(19) United States
(12) Patent Application Publication
(10) Pub. No.: US 2012/0005416 A1
(43) Pub. Date: Jan. 5, 2012

(54) DATA RECORDING METHOD AND DATA RECODING DEVICE TO IMPROVE OPERATIONAL RELIABILITY OF NAND FLASH MEMORY

(75) Inventors: Tae-min LEE, Hwaseong-si (KR); Jung-hoon Kim, Suwon-si (KR); Jin-Woo Jung, Seoul (KR); Kyoung-ryun Bae, Seongnam-si (KR)

(73) Assignee: Samsung Electronics Co., Ltd, Suwon-si (KR)

(21) Appl. No.: 13/174,984

(22) Filed: Jul. 1, 2011

(30) Foreign Application Priority Data
Jul. 1, 2010 (KR) 10-2010-0063431

(51) Int. Cl. G06F 12/06

(52) U.S. Cl. 711/103; 711/E12.078

(57) ABSTRACT

A data recording method and data recoding device to improve operational reliability of NAND flash memory includes calculating an address to record data, extracting information regarding a memory cell corresponding to the calculated address, selecting a data scrambling method based on the information regarding the memory cell, scrambling the data according to the data scrambling method, and recording the scrambled data on the memory cell. The information regarding the memory cell includes a logical block address, a logical page address, a physical block address, a physical page address of the memory cell, and a program/erase cycle of a memory block corresponding to the memory cell.

### CROSS-REFERENCE TO RELATED APPLICATIONS

This application claims priority under 35 U.S.C. §119(a) from Korean Patent Application No. 10-2010-0063431, filed on Jul. 1, 2010, in the Korean Intellectual Property Office, the disclosure of which is incorporated herein in its entirety by reference.

### BACKGROUND OF THE INVENTION

1. Field of the Invention

The inventive concept relates to a data recording method, and more particularly, to a data recording method to scramble data to be recorded on NAND flash memory, and a data recording device employing the data recording method.

2. Description of the Related Art

Due to the rapid spread of digital cameras and portable audio players, large-capacity non-volatile semiconductor memory is increasingly demanded. As non-volatile semiconductor memory, NAND flash memory is broadly used. NAND flash memory has a structure of a NAND string in which a plurality of memory cells are connected in series. As the capacity of NAND flash memory increases, the number of memory cells included in a NAND string also increases. As such, a data recording method that considers operational reliability of NAND flash memory is required.

### SUMMARY OF THE INVENTION

The inventive concept provides a data recording method to scramble data to be recorded on NAND flash memory.

The inventive concept also provides a data recording device employing the data recording method.

Additional feature and utilities of the present general inventive concept will be set forth in part in the description which follows and, in part, will be obvious from the description, or may be learned by practice of the general inventive concept.

According to a feature of the present general inventive concept, there is provided a data recording method of NAND flash memory in which a plurality of memory cells are connected in series, the method including calculating an address to record data; extracting information regarding a memory cell corresponding to the calculated address; selecting a data scrambling method based on the information regarding the memory cell; scrambling the data according to the data scrambling method; and recording the scrambled data on the memory cell.

The information regarding the memory cell may include a logical block address, a logical page address, a physical block address, and a physical page address of the memory cell, and a program/erase cycle of a memory block including the memory cell.

The data scrambling method may be a method of adding a sum of the logical block address and the logical page address to the data.

The data scrambling method may be a method of adding a sum of the physical block address and the physical page address to the data.

The data scrambling method may be a method of adding the program/erase cycle to the data.

The data scrambling method may be a method of adding a sum of the logical block address, the logical page address, the physical block address, and the physical page address to the data.

The data scrambling method may be a method of adding a sum of the physical block address, the physical page address, and the program/erase cycle to the data.

The data scrambling method may be a method of adding a sum of the logical block address, the logical page address, and the program/erase cycle to the data.

The data scrambling method may be a method of adding a sum of the logical block address, the logical page address, the physical block address, the physical page address, and the program/erase cycle to the data.

The information regarding the memory cell may be extracted from a memory block that stores log information, from among a plurality of memory blocks included in the NAND flash memory.

According to another feature of the inventive concept, there is provided a data recording device having NAND flash memory in which a plurality of memory cells are connected in series, the device including a control unit to calculate an address to record data, extracting information regarding a memory cell corresponding to the calculated address, selecting a data scrambling method based on the information regarding the memory cell, and scrambling the data according to the data scrambling method; and the NAND flash memory to record the scrambled data on the memory cell.

In another feature of the present general inventive concept, a data recording method of NAND flash memory in which a plurality of memory cells are connected in series comprises generating scrambled data based on memory cell information of a memory cell to store the scrambled data, determining a threshold voltage of the memory cell, and programming the memory cell with the scrambled data based on the threshold voltage.

In yet another feature of the present general inventive concept, a NAND flash memory control module comprises a processor module to extract memory cell information corresponding to a memory cell to store data and to output a selection signal to select a scrambling method that scrambles the data, a randomizer module to receive the selection signal and to generate scrambled data according to the scrambling method indicated by the selection signal, and a flash controller to determine a threshold voltage of the memory cell, and to program the memory cell with the scrambled data based on the threshold voltage.

### BRIEF DESCRIPTION OF THE DRAWINGS

Exemplary embodiments of the inventive concept will be more clearly understood from the following detailed description taken in conjunction with the accompanying drawings in which:

These and/or other features and utilities of the present general inventive concept will become apparent and more readily appreciated from the following description of the exemplary embodiments, taken in conjunction with the accompanying drawings of which:

FIG. 1 is a block diagram of a data recording medium according to an exemplary embodiment of the inventive concept;

FIG. 2 is a block diagram of a card controller illustrated in FIG. 1;

FIG. 3 is a block diagram of NAND flash memory illustrated in FIG. 1;

FIG. 4 is a circuit diagram of a memory block illustrated in FIG. 3;

FIG. 5 is a graph illustrating a threshold voltage distributing and programming method of a memory cell illustrated in FIG. 4;

FIG. 6 is a flowchart of a data scrambling method according to an exemplary embodiment of the inventive concept;

FIG. 7 is a table showing examples of a scrambling method illustrated in FIG. 6; and

FIGS. 8A and 8B are circuit diagrams illustrating operational reliability of the NAND flash memory illustrated in FIG. 3.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept while referring to the figures.

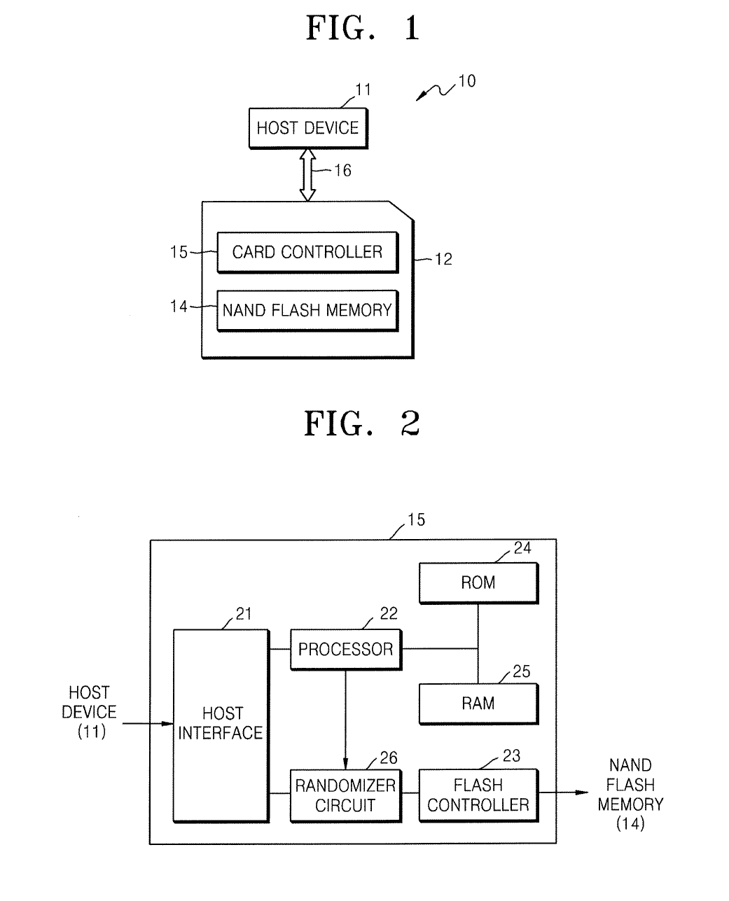

FIG. 1 is a block diagram of a data recording medium 10 according to an exemplary embodiment of the inventive concept. Referring to FIG. 1, the data recording medium 10 includes a host device 11 and a memory card 12. The host device 11 has hardware and software to access the memory card 12 connected to the host device 11 via a bus interface 16. The memory card 12 receives power when connected to the host device 11 and operates according to an access of the host device 11. The memory card 12 according to the current exemplary embodiment is described as an example of a data storage device.

The memory card 12 communicates with the host device 11 via the bus interface 16 to exchange various signals and data. The memory card 12 includes a NAND flash memory 14 and a card controller 15 to control the NAND flash memory 14. The bus interface 16 allocates a card detection signal, a command signal, a ground potential, a power potential, a clock signal, and a data signal by using a plurality of signal pins, e.g., nine signal pins, and the memory card 12 and a host controller (not shown) in the host device 11 are used to communicate.

Communication between the NAND flash memory 14 and the card controller 15 is performed according to an interface of the NAND flash memory 14. The NAND flash memory 14 and the card controller 15 are connected via, for example, an 8-bit input/output (I/O) line. When the card controller 15 records data on the NAND flash memory 14, the card controller 15 uses the 8-bit I/O line to sequentially input a data input command 80H, a column address, a page address, and a data and program command 10H to the NAND flash memory 14. Here, “H” in the command 80H refers to hexacode, and an 8-bit signal of “1000000” is substantially given in parallel to the 8-bit I/O line. That is, a command of a plurality of bits is given in parallel to the interface of the NAND flash memory 14. Also, the interface of the NAND flash memory 14 communicates by commonly using the 8-bit I/O line for commands and data regarding the NAND flash memory 14. As described above, the bus interface 16 to communicate between the host controller in the host device 11 and the memory card 12 is different from an interface to communicate between the NAND flash memory 14 and the card controller 15.

FIG. 2 is a block diagram of the card controller 15 illustrated in FIG. 1. Referring to FIG. 2, the card controller 15 manages a memory region divided into blocks and pages in the NAND flash memory 14, and controls a data recording or reading operation on or from the memory region. The card controller 15 includes a host interface 21, a processor 22, a flash controller 23, a read only memory (ROM) 24, a random access memory (RAM) 25, and a randomizer circuit 26.

The host interface 21 is an interface between the card controller 15 and the host device 11. The processor 22 controls general operation of the memory card 12 illustrated in FIG. 1. When the memory card 12 receives power, the processor 22 reads firmware or a control program stored in the ROM 24 and stores the firmware or the control program in the RAM 25. Also, the processor 22 controls the randomizer circuit 26 to scramble data to be recorded on the NAND flash memory 14.

The ROM 24 stores the control program to be controlled by the processor 22. The RAM 25 is used as an operation region of the processor 22, and stores a control program or temporary values to be processed. The flash controller 23 is an interface between the card controller 15 and the NAND flash memory 14. Accordingly, the flash controller may 23 may output the scrambled data from the randomizer circuit 26 to the NAND flash memory 14 such that the scrambled data is recorded on a memory cell among the plurality of memory cells.

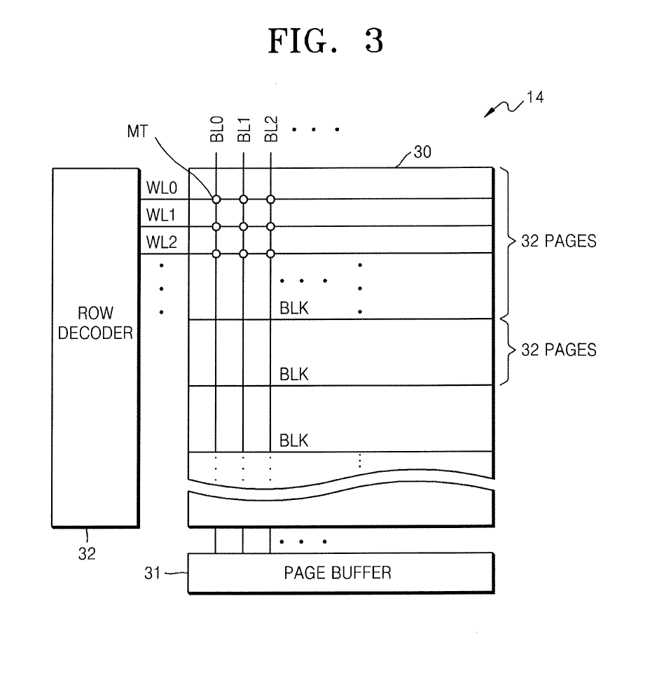

FIG. 3 is a block diagram of the NAND flash memory 14 illustrated in FIG. 1. Referring to FIG. 3, the NAND flash memory 14 includes a memory cell array 30, a page buffer 31, and a row decoder 32. The memory cell array 30 is divided into a plurality of memory blocks BLK. Each memory block BLK may comprise a plurality of pages, as described in greater detail below.

Each memory block BLK may perform as a data erasing unit and has a plurality of memory cell transistors (MT). The memory blocks BLK include a plurality of word lines WL0, WL1, WL2, etc., . . . and a plurality of bit lines BL0, BL1, BL2, etc., . . . perpendicular to the word lines, e.g., WL0, WL1, WL2. If not defined particularly, the word lines WL0, WL1, WL2, are referred to as word lines (WL), and the bit lines BL0, BL1, BL2, are referred to as bit lines (BL). The memory cell transistors MT in the same row are commonly connected to the same word line WL, and a set of such memory cell transistors MT is referred to as one page. Each page is a data recording or reading unit. Accordingly, each memory block BLK of the NAND flash memory 14 includes a plurality of pages, for example, 32 pages. It is appreciated that although exemplary embodiments referenced hereafter include memory blocks BLK comprising 32 pages, a memory block may include less or more pages including, but not limited to, 64 pages.

The page buffer 31 inputs and outputs data to and from the NAND flash memory 14, and temporarily retains data. A data size of the page buffer 31 is the same as a page size of a memory block BLK and is for example, 2048 bytes+64 bytes for error correcting code (ECC). The row decoder 32 selects a predetermined word line WL to start a data recording and reading operation.

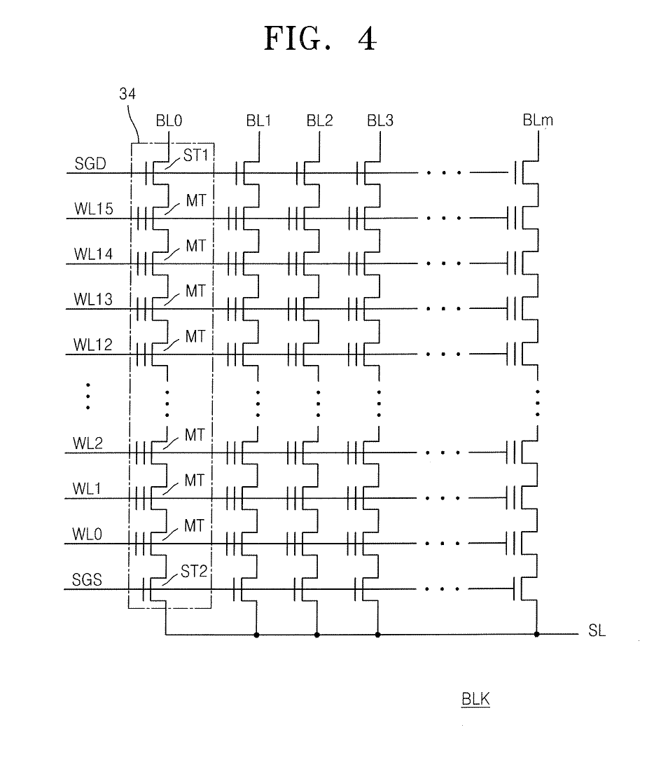

FIG. 4 is a circuit diagram of the memory block BLK illustrated in FIG. 3. Referring to FIG. 4, the memory block BLK includes (m+1) NAND strings 34, (m is a natural number) each including selection transistors ST1 and ST2 and 16 memory cell transistors MT. The number of the memory cell transistors MT included in a NAND string 34 is not limited to 16 and may also be, for example, 8, 32, 64, or 128. The selection transistor ST1 has a drain connected to a bit line BL and a gate connected to a selection gate line SGD. The selection transistor ST2 has a source connected to a source line SL and a gate connected to a selection gate line SGS.

Each memory cell transistor MT is a metal-oxide semiconductor (MOS) transistor in which a stacked gate is formed on a semiconductor substrate while intervening a gate insulating layer therebetween. The stacked gate includes a floating gate formed on the gate insulating layer, and a control gate formed on the floating gate while intervening an insulating layer between the gates. The memory cell transistor MT may be programmed by accumulating and trapping one or more electrical charges on the floating gate. Programming of the floating-gate may be achieved by biasing the drain of memory cell transistor MT to a first positive bias, relative to the source, and biasing the control gate to a second positive bias which is greater than the first positive bias. In the absence of a previously stored charge on the floating gate, biased drain and control gate cause the formation of an inversion-layer channel of electrons at the face of the substrate, between the source and drain. The drain-to-source voltage accelerates the electrons, which may be referred to as hot electrons, through the channel to the drain region. The larger positive bias on the control gate also generates an electrical field in a tunneling oxide layer that separates the floating gate from the channel region. This electric field attracts the hot electrons and accelerates them toward the floating gate, which is disposed between the control gate and the channel region. When the electrical field is weak, an electrical charge traveling toward the floating gate may be injected through the electrical field by a process known as tunneling injection, i.e., tunnel current. Accordingly, the floating gate then accumulates and traps the accumulated charge. The accumulated charge may represent a data bit such that the memory cell transistor MT may be programmed.

In each NAND string 34, 16 memory cell transistors MT are connected in series between a source of the selection transistor ST1 and a drain of the selection transistor ST2 to form a current path. A drain of a memory cell transistor MT, which includes a gate connected to a word line WL15, is connected to the source of the selection transistor ST1. Similarly, a source of a memory cell transistor MT, which includes a gate connected to a word line WL0, is connected to the drain of the selection transistor ST2.

Word lines WL0 through WL15 are connected to control gates of the memory cell transistors MT in a NAND string 34 of the memory blocks BLK. Control gates of the memory cell transistors MT in the same row of the memory blocks BLK are commonly connected to the same word line WL. Bit lines BL0 through BLm are connected to the drains of the selection transistors ST1 in the memory blocks BLK. The memory blocks BLK in the same column as a NAND string 34 is connected to one bit line BL. Hereinafter, the memory cell transistors MT are referred to as memory cells MC.

The memory cell MC may exist in an erase state or a program state according to a threshold voltage of each memory cell MC. The memory cell MC may have a relatively low voltage in the erase state, for example, a threshold voltage lower than 0V. Meanwhile, the memory cell MC may have a relatively high voltage in the program state, for example, a threshold voltage higher than 0V. A read operation, which needs to distinguish the state of a memory cell MC, may be accomplished by applying a read voltage to the selected memory cell MC, and by distinguishing whether the selected memory cell MC is turned on or off. For example, a voltage of 0V is applied to a word line of the selected memory cell MC. That is, if the selected memory cell MC is turned on, the selected memory cell MC may be in the erase state, because the threshold voltage is lower than the read voltage. Meanwhile, if the selected memory cell MC is turned off, the selected memory cell MC may be in the program state, because the threshold voltage is higher than the read voltage. It can be appreciated that a selected memory cell MC may be in the program state when the selected memory cell MC is turned on, and may be in the erase state when the selected memory cell MC is turned off, without deviating from the general scope described above.

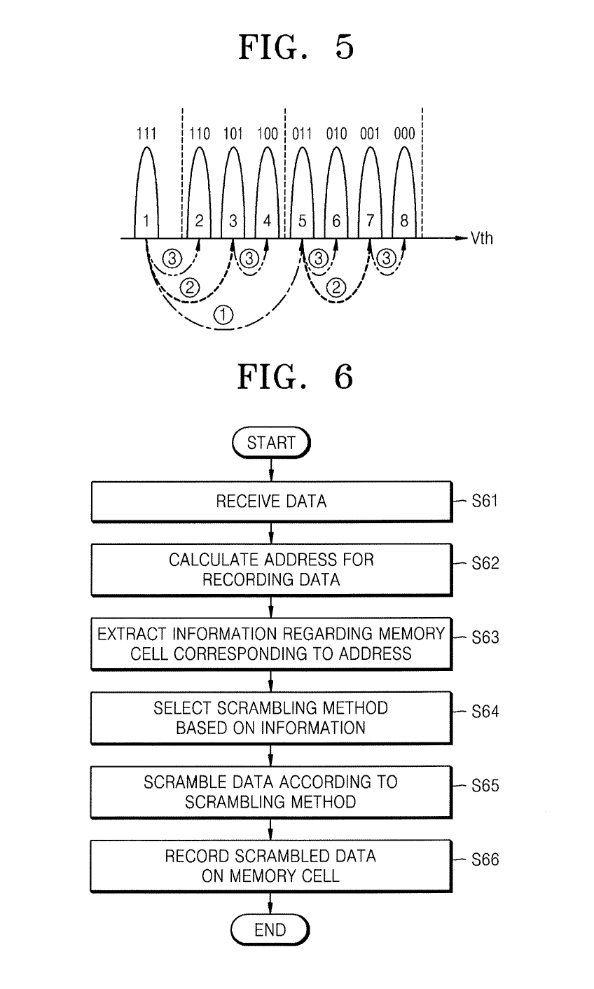

FIG. 5 is a graph describing a threshold voltage distributing and programming method of a memory cell MC (i.e., a memory cell transistor MT illustrated in FIG. 4). For convenience of explanation, FIG. 5 will be described on the assumption that the memory cell MC includes first through eighth threshold voltage distributions 1 through 8, and that 3-bit data is programmed in the memory cell MC. However, one of ordinary skill in the art would understand that the present general inventive concept is not limited to 8 threshold voltage distributions and 3-bit data.

In FIG. 5, the lowest threshold voltage distribution is the first threshold voltage distribution 1 and the highest threshold voltage distribution is the eighth threshold voltage distribution 8. Also, a code is represented above each threshold voltage distribution in FIG. 5. However, the inventive concept is not limited to the represented codes and other codes may also be used.

As mentioned above, it is assumed for exemplary purposes that 3-bit data is programmed in the memory cell MC. Accordingly, three programming operations may be used to program the memory cell MC. In a first programming operation 1, a first bit is programmed by using a first intermediate threshold voltage distribution and the lowest threshold voltage distribution. The first intermediate threshold voltage distribution may be the fifth threshold voltage distribution 5, and the lowest threshold voltage distribution, as described above, may be the first threshold voltage distribution 1. That is, in the first programming operation 1, the first bit may be programmed by using the first threshold voltage distribution 1 and the fifth threshold voltage distribution 5.

In a second programming operation 2, if the first bit is programmed to have the lowest threshold voltage distribution, a second bit is programmed by using the lowest threshold voltage distribution and a second intermediate threshold voltage distribution located between the lowest threshold voltage distribution and the first intermediate threshold voltage distribution. Otherwise, if the first bit is programmed to have the first intermediate threshold voltage distribution, the second bit is programmed by using the first intermediate threshold voltage distribution and a third intermediate threshold voltage distribution located between the first intermediate threshold voltage distribution and the highest threshold voltage distribution.

The second intermediate threshold voltage distribution may be the third threshold voltage distribution 3, and the third intermediate threshold voltage distribution may be the seventh threshold voltage distribution 7. That is, in the second programming operation 2, if the first bit is programmed to have the first threshold voltage distribution 1, the second bit may be programmed by using the first threshold voltage distribution 1 and the third threshold voltage distribution 3. Otherwise, if the first bit is programmed to have the fifth threshold voltage distribution 5, the second bit may be programmed by using the fifth threshold voltage distribution 5 and the seventh threshold voltage distribution 7.

In a third programming operation 3, a third bit may be programmed by using the first threshold voltage distribution 1 and the second threshold voltage distribution 2, the third threshold voltage distribution 3 and the fourth threshold voltage distribution 4, the fifth threshold voltage distribution 5 and the sixth threshold voltage distribution 6, or the seventh threshold voltage distribution 7 and the eighth threshold voltage distribution 8.

The flash memory controller 23 provides an interface between the card controller 15 and the NAND flash memory 14. Further, the flash memory controller 23 may receive the calculated address of the memory cell 14 from the processor 22, and may determine the threshold voltage distributions of the memory cell 14 to store the scrambled data output from the randomizer circuit 26. Accordingly, the flash memory controller may program the memory cell 14 with the scrambled data according to threshold voltage distributions, as discussed above.

FIG. 6 is a flowchart illustrating a data scrambling method according to an exemplary embodiment of the inventive concept. Referring to FIG. 6 in conjunction with FIGS. 1 through 3, initially, the memory card 12 receives a recording command and recording data to be recorded, from the host device 11. In more detail, the host interface 21 of the card controller 15 receives the recording command and the recording data (operation S61). The processor 22 calculates an address to record the recording data, according to the recording command (operation S62).

The processor 22 extracts information regarding a memory cell MC corresponding to the calculated address (operation S63). The information regarding the memory cell MC includes a logical block address, a logical page address, a physical block address, and a physical page address of the memory cell MC. The information regarding the memory cell MC may also include a program/erase cycle of a memory block BLK corresponding to the memory cell MC. The information regarding the memory cell MC may be extracted from a memory block BLK allocated to store log information of the memory card 12, from among the memory blocks BLK illustrated in FIG. 3.

After the memory cell information is extracted, the processor 22 determines the type and/or types of memory cell information extracted, and may select a scrambling method (operation S64), as discussed further below. The selected scrambling method may be executed by a control program stored in the ROM 24.

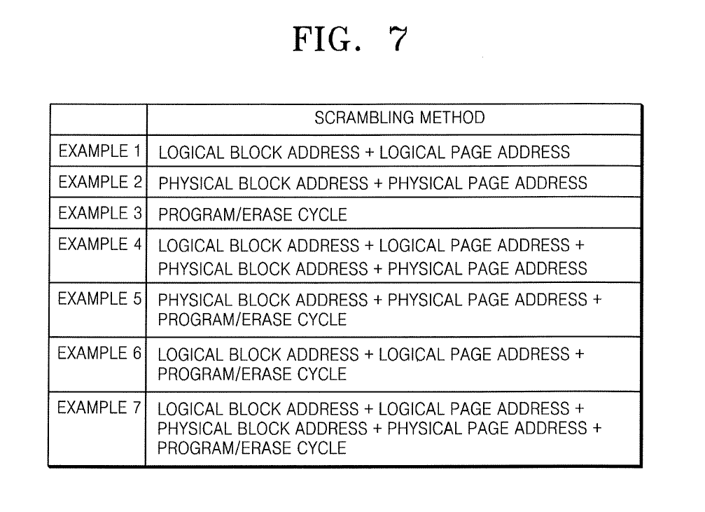

As illustrated in FIG. 7, a first example of the scrambling method is a method of adding a sum of the logical block address and the logical page address to the recording data. A second example of the scrambling method is a method of adding a sum of the physical block address and the physical page address to the recording data. A third example of the scrambling method is a method of adding a number of the program/erase cycle to the recording data. A fourth example of the scrambling method is a method of adding a sum of the logical block address, the logical page address, the physical block address, and the physical page address to the recording data. A fifth example of the scrambling method is a method of adding a sum of the physical block address, the physical page address, and the program/erase cycle to the recording data. A sixth example of the scrambling method is a method of adding a sum of the logical block address, the logical page address, and the program/erase cycle to the recording data. A seventh example of the scrambling method is a method of adding a sum of the logical block address, the logical page address, the physical block address, the physical page address, and the program/erase cycle to the recording data. Accordingly, if the processor 22 determines that the extracted memory cell information includes a logical block address and a logical page address, the processor 22 may output a selection signal to select Example 1 such that a sum of the logical block address and the logical page address is added to the recording data. In another example, if the processor 22 determines that the extracted memory cell information is a program/erase cycle, the processor 22 may output a selection signal select Example 3 such that a number of the program/erase cycle is added to the recording data.

The processor 22 commands the randomizer circuit 26 based on the selection signal to perform the scrambling method, and the randomizer circuit 26 scrambles the recording data according to the scrambling method (operation S65). After that, the scrambled recording data scrambled by the randomizer circuit 26 is recorded on the memory cell (operation S66).

In comparison to a typical data recording method using a scramble table, the data recording method according to the at least one exemplary embodiment of the present general inventive concept does not require a process of reading seed data stored in the scramble table and storing the read seed data in a register. In addition, the data recording method according to the at least one exemplary embodiment of the present general inventive concept does not use a scramble table and thus is not required to allocate an additional region to store the scramble table, e.g., a partial region of the RAM 25 in the card controller 15. Also, when scrambled data is typically descrambled, if seed data stored in a spare region of a page in NAND flash memory is damaged, the damaged seed data may not be easily restored. However, the data recording method according to the at least one exemplary embodiment of the present general inventive concept is not required to store seed data in a spare region of a page in the NAND flash memory 14. Also, operational reliability of the NAND flash memory 14 may be improved.

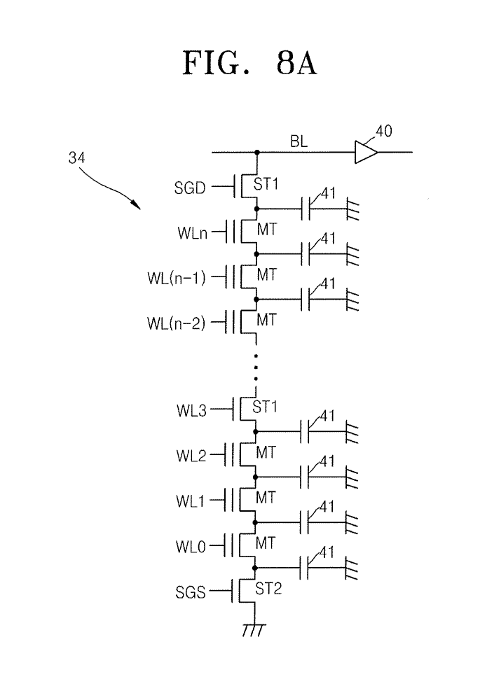

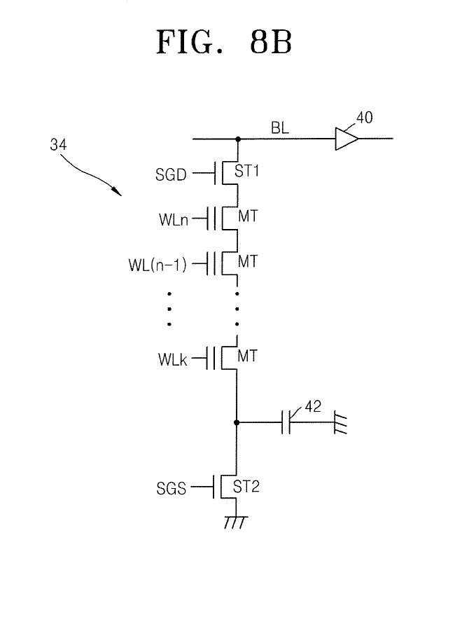

FIGS. 8A and 8B are circuit diagrams describing operational reliability of the NAND flash memory 14 illustrated in FIG. 3. Referring to FIG. 8A, one NAND string 34 in the NAND flash memory 14 is illustrated. The NAND string 34 includes (n+1) memory cell transistors MT (n is a natural number) and a page buffer 40 to sense reading data of a bit line BL. Each memory cell transistor MT includes a parasitic capacitance 41. The parasitic capacitance 41 is formed between a source/drain of a memory cell transistor MT and a substrate corresponding to each memory cell transistor MT.

The NAND flash memory 14 employs a data recording method using a tunneling current. Current driving characteristics of the memory cell transistors MT are represented as a function of the resistance of a source and the thickness of a gate oxide layer. As the thickness of the gate oxide layer is small, the current driving characteristics of the memory cell transistors MT are good. As the thickness of the gate oxide layer is small, if a negative (−) bias is applied to a gate and a positive (+) bias is applied to an N-type drain, a depletion layer is formed on the N-type drain toward a lower surface of the gate and a band deforms. As a value of a negative voltage applied to the gate is large, the band is bent more and depletion is increased. As such, a high electric field is formed between the gate and the drain and thus a gate induced drain lowering (GIDL) phenomenon in which a current is increased as direct current tunneling occurs and charges are injected on the floating gate.

As illustrated in FIG. 8B, if the memory cell transistors MT connected to word lines WL0 through WL(k−1), where k is a natural number, are turned on, a quite large parasitic capacitance 42 is formed in a NAND string 34. That is, the parasitic capacitance 42 is formed when the parasitic capacitances 41 of the memory cell transistors MT connected to the word lines WL0 through WL(k−1) are connected in parallel between a selection transistor ST2 and the memory cell transistors MT connected to a word line WLk.

For example, when a reading voltage is applied to the word line WL0, a large amount of charge supplied from the parasitic capacitance 42 is accelerated to a gate of the word line WL0, thereby generating hot electrons. The hot electrons generated due to the GIDL phenomenon are transferred to a tunnel oxide film of the memory cell transistor MT connected to the word line WL0 and may destroy recording data recorded in the memory cell transistor MT. This phenomenon is referred to as read disturb. In particular, as described above in FIG. 5, data may not be easily retained in multi-level cells having a small difference in threshold voltage.

In order to reduce a chip size of the NAND flash memory 14, the number of memory cell transistors MT in the NAND string is increased. As a result, a current applicable to the NAND string, as well as a variation in voltage or a current value required to read and sense data, is reduced. However, as the number of memory cell transistors MT connected to the NAND string in series is large, and more particularly, as a large number of continuous memory cell transistors MT are turned on, resistance against a read disturb phenomenon and a program disturb phenomenon is reduced.

The by scrambling the data according to the scrambling methods described above, a read disturb phenomenon and/or a program disturb phenomenon may be reduced. That is, based on the data recording method illustrated in FIG. 6, data recorded in a direction of a word line WL of the NAND flash memory 14 is scrambled. When the same data is recorded in a large number of continuous memory cells MC, the same data is prevented from being recorded on neighboring word lines WL. As such, operational reliability of the NAND flash memory 14 may be improved with respect to the GIDL phenomenon, the read disturb phenomenon, and the program disturb phenomenon.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A data recording method of NAND flash memory in which a plurality of memory cells are connected in series, the method comprising:
calculating an address to record data;
extracting information regarding a memory cell corresponding to the calculated address;
selecting a data scrambling method based on the information regarding the memory cell;
scrambling the data according to the data scrambling method; and
recording the scrambled data on the memory cell.

2. The data recording method of claim 1, wherein the information regarding the memory cell comprises a logical block address, a logical page address, a physical block address, and a physical page address of the memory cell, and a program/erase cycle of a memory block comprising the memory cell.

3. The data recording method of claim 2, wherein the data scrambling method is a method of adding a sum of the logical block address and the logical page address to the data.

4. The data recording method of claim 2, wherein the data scrambling method is a method of adding a sum of the physical block address and the physical page address to the data.

5. The data recording method of claim 2, wherein the data scrambling method is a method of adding the program/erase cycle to the data.

6. The data recording method of claim 2, wherein the data scrambling method is a method of adding a sum of the logical block address, the logical page address, the physical block address, and the physical page address to the data.

7. The data recording method of claim 2, wherein the data scrambling method is a method of adding a sum of the physical block address, the physical page address, and the program/erase cycle to the data.

8. The data recording method of claim 2, wherein the data scrambling method is a method of adding a sum of the logical block address, the logical page address, and the program/erase cycle to the data.

9. The data recording method of claim 2, wherein the data scrambling method is a method of adding a sum of the logical block address, the logical page address, the physical block address, the physical page address, and the program/erase cycle to the data.

10. The data recording method of claim 2, wherein the information regarding the memory cell is extracted from a memory block that stores log information, from among a plurality of memory blocks comprised in the NAND flash memory.

11. A data recording device having NAND flash memory in which a plurality of memory cells are connected in series, the device comprising:
a control unit to calculate an address to record data, to extract information regarding a memory cell corresponding to the calculated address, to select a data scrambling method based on the information regarding the memory cell, and to scramble the data according to the data scrambling method; and
a flash controller in electrical communication between the control unit and the NAND flash memory to output the scrambled data to the NAND flash memory such that the scrambled data is recorded on a memory cell among the plurality of memory cells.

12. The data recording device of claim 11, wherein the information regarding the memory cell comprises a logical block address, a logical page address, a physical block address, and a physical page address of the memory cell, and a program/erase cycle of a memory block comprising the memory cell.

13. The data recording device of claim 12, wherein the data scrambling method is a method of adding a sum of the logical block address and the logical page address to the data.

14. The data recording device of claim 12, wherein the data scrambling method is a method of adding a sum of the physical block address and the physical page address to the data.

15. The data recording device of claim 12, wherein the data scrambling method is a method of adding the program/erase cycle to the data.

16. The data recording device of claim 12, wherein the data scrambling method is a method of adding a sum of the logical block address, the logical page address, the physical block address, and the physical page address to the data.

17. The data recording device of claim 12, wherein the data scrambling method is a method of adding a sum of the physical block address, the physical page address, and the program/erase cycle to the data.

18. The data recording device of claim 12, wherein the data scrambling method is a method of adding a sum of the logical block address, the logical page address, and the program/erase cycle to the data.

19. The data recording device of claim 12, wherein the data scrambling method is a method of adding a sum of the logical block address, the logical page address, the physical block address, the physical page address, and the program/erase cycle to the data.

20. The data recording device of claim 12, wherein the information regarding the memory cell is extracted from a memory block that stores log information, from among a plurality of memory blocks comprised in the NAND flash memory.

21. A data recording method of NAND flash memory including a plurality of memory cells connected in series, the method comprising:
generating scrambled data based on memory cell information of a memory cell to store the scrambled data;
determining a threshold voltage of the memory cell; and
programming the memory cell with the scrambled data based on the threshold voltage.

22. The data recording method of claim 21, wherein the threshold voltage includes a plurality of threshold voltage distributions.

23. The data recording method of claim 22, wherein the plurality of threshold voltage distributions includes a lowest threshold voltage distribution, at least one intermediate threshold voltage distribution, and a highest threshold voltage distribution.

24. A NAND flash memory control module, comprising:
a processor module to extract memory cell information corresponding to a memory cell to store data and to output a selection signal to select a scrambling method that scrambles the data;
a randomizer module to receive the selection signal and to generate scrambled data according to the scrambling method indicated by the selection signal; and
a flash controller to determine a threshold voltage of the memory cell, and to program the memory cell with the scrambled data based on the threshold voltage.

25. The NAND flash memory control module of claim 24, wherein the threshold voltage includes a plurality of threshold voltage distributions.
